(19) United States
(12) Patent Application Publication
(10) Pub. No.: US 2026/0140243 A1
(43) Pub. Date: May 21, 2026

(54) METHOD FOR ASCERTAINING A BLINDNESS OF AN ULTRASONIC SENSOR OF AN ULTRASONIC SYSTEM, AND ULTRASONIC SYSTEM

(71) Applicant: Robert Bosch GmbH, Stuttgart (DE)

(72) Inventors: Albrecht Klotz, Leonberg (DE); Daniel Lorincz, Eindhoven (NL)

(21) Appl. No.: 19/114,487

(22) PCT Filed: Oct. 17, 2023
(86) PCT No.: PCT/EP2023/078751

§ 371 Date: Mar. 24, 2025

(30) Foreign Application Priority Data
Oct. 18, 2022 (DE) 10 2022 211 009.9

(51) Int. Cl. G01S 7/52; G01S 15/931

(52) U.S. Cl. CPC G01S 7/52004; G01S 15/931

(57) ABSTRACT

A method for ascertaining a blindness of an ultrasonic sensor of an ultrasonic system and an ultrasonic system. The method includes: a first step for transmitting an ultrasonic signal using a first ultrasonic sensor of the ultrasonic system into an environment of the first ultrasonic sensor, a second step for generating a first measurement signal, which represents first ground echoes of the transmitted ultrasonic signal that are received by the first sensor, a third step for generating a second measurement signal, which represents second ground echoes of the transmitted ultrasonic signal that are received by a second sensor of the ultrasonic system, a fourth step for normalizing the first measurement signal and the second measurement signal, and a fifth step for ascertaining a blindness of the first ultrasonic sensor and/or of the second ultrasonic sensor by comparing the first measurement signal with the second measurement signal.

### FIELD

The present invention relates to a method for ascertaining a blindness of an ultrasonic sensor of an ultrasonic system and to an ultrasonic system, in particular an ultrasonic system for a vehicle.

### BACKGROUND INFORMATION

Some ultrasonic systems for vehicles, which are used, for example, for providing parking and/or maneuvering functions of the vehicles, are described in the related art. Due to soiling and/or precipitation in the area of a field of view of ultrasonic sensors of the ultrasonic systems, it is possible that a detection capability of the ultrasonic sensors deteriorates or that the ultrasonic sensors become completely blind to their environment.

For this reason, ultrasonic systems generally have a blindness detection function. In the past, primarily sensor ringing and/or a presence of echoes with temporarily increased sensitivity (lowering of the sensor characteristic curve) and/or an evaluation of crosstalk signals between sensors was evaluated for detecting blindness of ultrasonic sensors.

In modern ultrasonic systems, alternatively or additionally, an impedance of a sensor transducer is often determined continuously in measurement mode and compared with a reference value. Changes with respect to an impedance characteristic are interpreted as potential soiling adhering to a membrane of the ultrasonic sensors. For loose deposits on the membrane (e.g., snow), which do not result in any change in impedance but to signal attenuation, a relative comparison of ground echoes (i.e., diffuse reflections which are generated by a ground region in the environment of the vehicle and are also called ground clutter) with corresponding direct echoes of the corresponding ultrasonic sensors is often used for blindness detection. Accordingly, significant reductions in the ground clutter, starting from a predefined expected value, are interpreted as potential sensor blindness.

### SUMMARY

According to a first aspect of the present invention, a method for ascertaining a blindness of an ultrasonic sensor of an ultrasonic system is provided, wherein the method is particularly advantageously usable in connection with an ultrasonic system for a vehicle. Such a vehicle is, for example, a road vehicle (e.g., motorcycle, car, van, truck) or a rail vehicle. The method according to the present invention is described representatively below in connection with a use in such a vehicle, without thereby being restricted to such an area of use.

The method according to the present invention can be carried out, for example, on the basis of an evaluation unit, which is configured to execute a computer program implementing the method. The evaluation unit is, for example, a component part of an ultrasonic control device of the ultrasonic system, which is advantageously connected to all ultrasonic sensors of the ultrasonic system by information technology. This enables the evaluation unit to transmit measurement requests to all or a portion of the ultrasonic sensors of the ultrasonic system and/or to receive measurement signals of the corresponding ultrasonic sensors in order to further process them. This explicitly does not exclude that parts of the method according to the present invention are carried out by the ultrasonic sensors themselves, or that one or more of the ultrasonic sensors fully assumes the task of centrally evaluating measurement signals, etc.

According to an example embodiment of the present invention, in a first step of the method according to the present invention, an ultrasonic signal is transmitted by means of a first ultrasonic sensor of the ultrasonic system into an environment of the first ultrasonic sensor. For example, the first ultrasonic sensor is an ultrasonic sensor that is arranged in a front region of a vehicle and oriented forward in the driving direction (i.e., in the main driving direction of the vehicle, i.e., in the forward direction) of the vehicle, wherein any other arrangement positions (e.g., in the rear region, on a side of the vehicle, etc.) are also possible. The transmission of the ultrasonic signal is initiated, for example, on the basis of a request by the evaluation unit. Alternatively or additionally, the ultrasonic signal is transmitted on the basis of a predefined transmission pattern by the first ultrasonic sensor itself.

In a second step of the method according to the present invention, the first ultrasonic sensor generates a first measurement signal, which represents first ground echoes (also called ground clutter) of the transmitted ultrasonic signal that are received by the first ultrasonic sensor. Ground echoes are understood to mean the diffuse portions of the transmitted ultrasonic signal that are predominantly generated by the ultrasonic signal scattering on a ground surface in the environment of the ultrasonic system and in this way are proportionally reflected to one or more ultrasonic sensors of the ultrasonic system. Typical but non-limiting distances at which ground echoes are generated, are, for example, in a range of 0.5 m to 2 m, or even beyond. These distances are inter alia dependent on an installation position of the ultrasonic sensor, on the vertical opening angle thereof, etc. In this respect, it is possible that the first measurement signal has a plurality of temporally successive measured values, which represent, for example, samples that have been detected within a detection period in which ground echoes are to be expected after the transmission of the corresponding ultrasonic signal. Alternatively or additionally, it is possible that the first measurement signal has one or more representative measured values calculated from the plurality of samples of such a detection period. For example, the measurement signal may have a single measured value, which represents an integration of the individual samples of the detection period. In addition, any other suitable calculations of individual samples are possible.

In a third step of the method according to the present invention, a second ultrasonic sensor of the ultrasonic system generates a second measurement signal, which represents second ground echoes of the ultrasonic signal transmitted by the first ultrasonic sensor that are received by the second ultrasonic sensor. These second ground echoes are also called cross echoes since they are generated by the transmit signal of the adjacent first ultrasonic sensor and not by a separate transmit signal of the second ultrasonic sensor. For this purpose, the second ultrasonic sensor is arranged in an environment of the first ultrasonic sensor in which sufficient detection of ground echoes generated by the ultrasonic signal of the first ultrasonic sensor is possible. In general, the fields of view of the first ultrasonic sensor and of the second ultrasonic sensor must have sufficiently high overlap to achieve reliable results by means of the method. Accordingly, it is irrelevant whether the first ultrasonic sensor and the second ultrasonic sensor are directly adjacent ultrasonic sensors, or whether they are ultrasonic sensors between which one or more further ultrasonic sensors are arranged, as long as a corresponding cross-echo reception by the ultrasonic sensors involved is ensured. Provided that this is the case, it is thus possible for the ultrasonic sensors to be arranged as desired (for example, arranged at any vertical and/or horizontal and/or depth offset from one another). The second measurement signal is preferably generated in the same way as the first measurement signal; reference is therefore made to the above statements on the first measurement signal.

In a fourth step of the method according to the present invention, the first measurement signal and the second measurement signal, i.e., their respective measured values, are normalized in order to establish comparability between the measurement signals and/or to quantify a degree of blindness of corresponding ultrasonic sensors. In other words, the normalization is preferably carried out in such a way that, in a case in which the field of view of the two ultrasonic sensors is not impaired by soiling or the like (i.e., in a case in which there is no soiling-related attenuation of the received ground echoes), the first measurement signal and the second measurement signal are very similar after the normalization. Advantageously, this normalization is carried out by means of the evaluation unit proposed above, in which the first and second measurement signals from the ultrasonic sensors can be received and temporarily stored.

In a fifth step of the method according to the present invention, a blindness of the first ultrasonic sensor and/or of the second ultrasonic sensor is ascertained by comparing the first measurement signal with the second measurement signal. This is made possible in that the measurement signals or the respective measured values of the measurement signals in the non-blind or non-visually-impaired state of the ultrasonic sensors are highly similar due to the normalization and in that a blindness can thus be identified if one measurement signal has significant deviations from the other measurement signal. Significant deviations exist, for example, when a magnitude of a difference between the first measurement signal and the second measurement signal exceeds a predefined blindness threshold value. As an alternative or in addition to the simple classification of corresponding sensors into the states “blind” or “not blind,” it is also possible according to the present invention to ascertain different degrees of blindness of the corresponding ultrasonic sensors in the fifth step and/or in a later step.

It should be noted in general that the method according to the present invention can also advantageously be used if multiple ultrasonic sensors of the ultrasonic system are configured to transmit distinguishable ultrasonic signals simultaneously. In such a case, the method according to the present invention is preferably carried out multiple times (e.g., in parallel and/or quasi-parallel), wherein, according to the method, different ultrasonic sensors are in each case considered as the first ultrasonic sensor. Distinguishability of simultaneously transmitted ultrasonic signals of multiple transmitters can inter alia be ensured on the basis of a code-division multiplexing method and/or a frequency-division multiplexing method.

In addition to the advantage of particularly reliable detection and/or quantification of a potentially existing blindness of the ultrasonic sensors of the ultrasonic system due to the inclusion of cross echoes received by currently non-transmitting ultrasonic sensors, the present invention additionally offers the advantage of particularly fast detection of an existing blindness, as a result of which downstream systems (e.g., driver assistance systems and/or autonomous driving systems, etc.) of the vehicle can initiate measures correspondingly early to manage an existing blindness. This can inter alia increase safety when operating the vehicle.

A further advantage of the method according to the present invention results in that normalizing the measurement signals achieves a broad independence of the result of the method from the particular ground properties or roadway properties.

Preferred developments of the present invention are disclosed herein.

In an advantageous embodiment of the present invention, normalizing compensates for deviations with respect to respective orientations of the first and second ultrasonic sensors (i.e., deviations with respect to respective radiation and/or reception angles) and/or with respect to respective arrangement positions (e.g., height deviations on the vehicle, etc.) of the first and second ultrasonic sensors. Alternately or additionally, normalizing compensates for deviations with respect to respective geometric attenuations and/or sound travel paths of the ultrasonic sensors. Different sound travel paths have the effect, for example, that the ultrasonic signal transmitted by the first ultrasonic sensor passes through potentially existing soiling on the first ultrasonic sensor twice (when it is transmitted and when the ground echoes of the ultrasonic signal are received) and thus experiences greater attenuation than the ground echoes received in the second ultrasonic sensor. Further alternatively or additionally, normalizing compensates for deviations with respect to technical properties (e.g., due to manufacturing tolerances of identical sensors and/or due to use of differently designed sensors and/or of different transmission functions of the ultrasonic sensors, etc.) of the first ultrasonic sensor and of the second ultrasonic sensor.

In a particularly advantageous embodiment of the present invention, when ascertaining the blindness of the first ultrasonic sensor and/or of the second ultrasonic sensor, a degree of the blindness and/or the transmissivity (i.e., a degree of the transmittance of ultrasonic signals from the ultrasonic sensor into an environment of the ultrasonic sensor, or vice versa) of the corresponding ultrasonic sensor is quantified by normalizing the signal values represented by the measurement signals to the signal values of the ultrasonic sensor that transmitted the ultrasonic signal and/or has the highest signal value, in terms of magnitude, within the measurement signal. In particular, normalizing to the highest signal value, in terms of magnitude, can at least partially eliminate an influence of different roadway properties and/or other influences acting substantially uniformly on the different ultrasonic sensors, as a result of which a degree of the blindness and/or the transmissivity can be determined directly and with a high reliability on the basis of the resulting signal values.

Advantageously, depending on the ascertained degree of the blindness and/or the transmissivity, a range of the corresponding ultrasonic sensors is ascertained and/or a graduated error handling and/or system degradation is carried out. This results in the particular advantage that dirty ultrasonic sensors can continue to be operated within their current range and do not have to be deactivated and/or excluded from processing. In addition, depending on the respective available ranges of the ultrasonic sensors, targeted error handling can be performed, as a result of which, for example, higher availability can be provided by the ultrasonic system according to the present invention.

Preferably, the method according to an example embodiment of the present invention is carried out by additionally including at least a third measurement signal of at least a third ultrasonic sensor, wherein a field of view of the third ultrasonic sensor has sufficient overlap with the field of view of the first and/or of the second ultrasonic sensor. The processing of the third measurement signal is preferably carried out analogously to the processing of the first and of the second measurement signal so that a comparison between the first, the second, and the third measurement signal is made possible in order to ascertain a blindness of the involved ultrasonic sensors on the basis thereof. For example, the first, the second, and the third ultrasonic sensor are arranged at predefined distances from one another in the area of a front apron of a vehicle. Further preferably, the method according to the present invention is carried out on the basis of further ultrasonic sensors, the measurement signals of which also flow into the result of the method.

In a further advantageous example embodiment of the present invention, the method is carried out and/or a result of the method is classified as reliable only if interference signals contained in the ground echoes are below a predefined threshold value, wherein the interference signals are in particular caused by noise and/or by direct echoes of objects in the environment of the ultrasonic sensors that are within the distance range of the ground echoes. This can be accomplished, for example, by ascertaining a number and/or respective levels of direct echoes within the distance range of the ground echoes and comparing them with corresponding threshold values. Alternatively or additionally, the method is carried out and/or a result of the method is classified as reliable only if predefined expected values for direct echoes received in addition to the ground echoes (preferably direct echoes outside the ground echo range) are met and/or the result has been successfully checked for plausibility by means of at least one further measurement signal of at least one further ultrasonic sensor. For example, the expected values with respect to the direct echoes relate to a certain minimum number and/or a certain distance at which direct echoes are typically generated in the environment of the ultrasonic system. In a case in which such direct echoes are not detected or are detected only at very low amplitude by one or more ultrasonic sensors of the ultrasonic system, soiling/blindness of the corresponding ultrasonic sensors can be assumed with high probability. Checking the plausibility via at least one further ultrasonic sensor can be carried out particularly advantageously by means of one or more ultrasonic sensors the field of view of which does not have any overlap with the first and second (and possibly third or further) ultrasonic sensors. For example, these ultrasonic sensors used to check the plausibility of the method are arranged in a rear region of the vehicle with an orientation opposite to the driving direction, while the first and second ultrasonic sensors, etc. are arranged in a front region of the vehicle with an orientation in the driving direction. This reduces a probability of substantially uniform soiling of all involved ultrasonic sensors so that such ultrasonic sensors arranged in the rear region can be used particularly advantageously to check the plausibility of the method, in particular if the ultrasonic sensors arranged in the front region have a substantially uniform blindness and thus do not make reliable blindness detection on the basis of the method according to the present invention possible (since differences in the corresponding measurement signals, which are required for the measurement signal comparison according to the present invention, essentially cannot be found).

According to an example embodiment of the present invention, advantageously, the result of the method is checked for plausibility and/or reconciled by means of a result of a different blindness detection method, in which an impedance of each transducer of the corresponding ultrasonic sensors and/or a ratio of ground echoes to direct echoes of the corresponding ultrasonic sensors is ascertained. These two different methods are preferably implemented according to conventional methods, which are carried out in parallel with the method according to the present invention. Through the reconciliation and/or plausibility check of the result of the method according to the present invention with the result of at least one conventional blindness detection method, a particularly high reliability for the blindness detection of ultrasonic sensors can be achieved.

Alternatively or additionally, according to an example embodiment of the present invention, the blindness of the particular ultrasonic sensors is ascertained on the basis of multiple measurements by the ultrasonic sensors (i.e., multiple measurements by means of the first ultrasonic sensor and by means of the second ultrasonic sensor in the corresponding method steps), the results of which are reconciled with one another. An overall result can be calculated from the individual results, for example by a majority decision. This allows individual incorrect measurements and/or measurements under unfavorable boundary conditions to be filtered out so that a correspondingly more robust overall result is obtained. This can in particular also be applied to the ascertained degree of an existing blindness and/or a transmissivity. For example, unfavorable boundary conditions that are compensable thereby include uneven flooring, which may produce non-identical ground echoes for different ultrasonic sensors, and/or puddles on the roadway, which affect only a portion of the ground echoes of the involved ultrasonic sensors, etc.

The method according to the present invention is further advantageously carried out multiple times while the assignment as to which of the ultrasonic sensors of the ultrasonic system assumes the function of the transmitting ultrasonic sensor is adjusted according to a predefined transmission pattern during the multiple execution of the method. By means of such a “rotation method” for transmitting the ultrasonic signal, a reliability of the method can be further increased since any unfavorable transmitting/receiving constellations in certain definitions of transmitters and receivers can be detected and/or compensated in this way.

According to a second aspect of the present invention, an ultrasonic system, in particular an ultrasonic system for a vehicle, is provided and comprises at least a first ultrasonic sensor, at least a second ultrasonic sensor, and an evaluation unit. The evaluation unit is designed, for example, as an ASIC, FPGA, processor, digital signal processor, microcontroller, or the like and advantageously is a component part of a central ultrasonic control device, or an independent component. According to an example embodiment of the present invention, the first ultrasonic sensor is configured to transmit an ultrasonic signal into an environment of the first ultrasonic sensor and to generate a first measurement signal, which represents first ground echoes of the transmitted ultrasonic signal that are received by the first sensor. The second ultrasonic sensor is configured to generate a second measurement signal, which represents second ground echoes of the transmitted ultrasonic signal that are received by the second sensor of the ultrasonic system. The evaluation unit is configured to normalize the first measurement signal and the second measurement signal and to ascertain a blindness of the first ultrasonic sensor and/or of the second ultrasonic sensor by comparing the first measurement signal with the second measurement signal. The features, feature combinations and the resulting advantages correspond to those listed in connection with the first-mentioned aspect of the present invention, in such an obvious manner that reference is made to the above statements in order to avoid repetitions.

### BRIEF DESCRIPTION OF THE DRAWINGS

Embodiment examples of the present invention are described in detail below with reference to the figures.

FIG. 1 shows a flow chart of an embodiment example of a method according to the present invention for ascertaining a blindness of an ultrasonic sensor of an ultrasonic system.

FIG. 2 shows a schematic view of an ultrasonic system according to an example embodiment of the present invention in connection with a vehicle.

### DETAILED DESCRIPTION OF EXAMPLE EMBODIMENTS

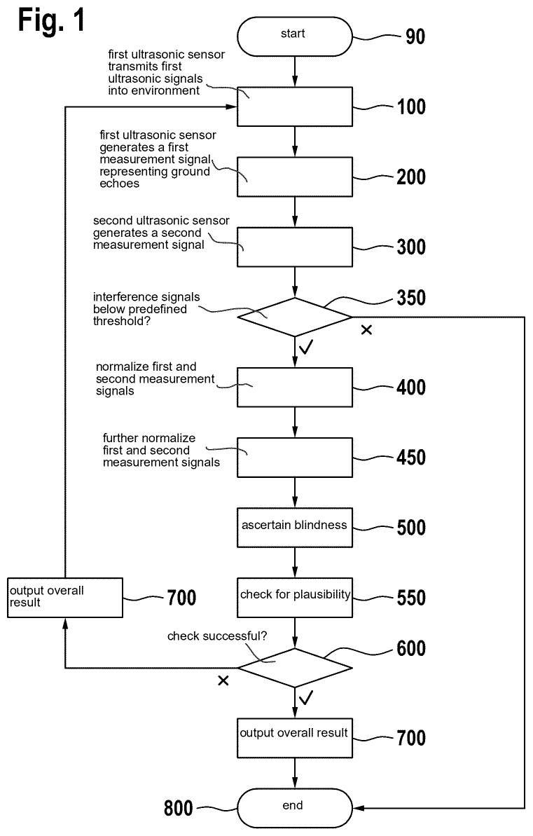

FIG. 1 shows a flow chart of an embodiment example of a method according to the present invention for ascertaining a blindness of an ultrasonic sensor of an ultrasonic system. The ultrasonic system is here, by way of example, an ultrasonic system for a vehicle that is used for environmental detection of the vehicle.

Starting from a start node 90, the method starts by carrying out step 100, in which a first ultrasonic sensor of the ultrasonic system transmits an ultrasonic signal into an environment of the first ultrasonic sensor.

In step 200 of the method according to the present invention, the first ultrasonic sensor generates a first measurement signal, which represents first ground echoes of the transmitted ultrasonic signal that are received by the first ultrasonic sensor.

In step 300 of the method according to the present invention, a second ultrasonic sensor of the ultrasonic system generates a second measurement signal, which represents second ground echoes of the transmitted ultrasonic signal that are received by the second ultrasonic sensor of the ultrasonic system.

Here, the first ultrasonic sensor and the second ultrasonic sensor are each arranged in a front region of the vehicle and their respective fields of view, both oriented in the driving direction of the vehicle, have a predefined overlap so that ultrasonic signals transmitted by one of the ultrasonic sensors can be received by the other ultrasonic sensor proportionally in the form of echoes of the ultrasonic signals.

In step 350 of the method according to the present invention, it is checked whether interference signals contained in the particular ground echoes are below a predefined threshold value, wherein the interference signals are caused by noise and/or by direct echoes that are located within the distance range of the ground echoes. In the event that the interference signals reach or exceed the threshold value, the current pass of the method is terminated in end node 800 since a required reliability of the method according to the present invention cannot be ensured due to the level of the interference signals.

In the event that the interference signals are below the threshold value, the first measurement signal and the second measurement signal are normalized in step 400 of the method according to the present invention. Normalizing compensates for different orientations, arrangement positions, geometric attenuations, sound travel paths, and technical properties of the first ultrasonic sensor and of the second ultrasonic sensor in order to establish comparability of the first measurement signal and the second measurement signal.

In step 450 of the method according to the present invention, the two measurement signals are normalized further by normalizing the signal values represented by the measurement signals to the signal values of the ultrasonic sensor that has the highest signal value, in terms of magnitude, within the measurement signal. This makes it possible to quantify a blindness of the ultrasonic sensors that is to be determined subsequently, since the further normalization makes it possible to assess the measurement signals independently of environmental conditions. Such environmental conditions are in particular different surface properties of a roadway of the vehicle, which can result in different forms of the ground echoes. A magnitude of the particular signal values after normalization is here between the values of zero and one.

In step 500 of the method according to the present invention, a blindness of the first ultrasonic sensor and/or of the second ultrasonic sensor is ascertained by comparing the first measurement signal with the second measurement signal. In a case in which, for example, a highest signal value, in terms of magnitude, in the first measurement signal corresponds to a value of one and a highest signal value, in terms of magnitude, in the second measurement signal corresponds to a value of 0.5, an existing blindness, which is represented by a 50% transmissivity of the second ultrasonic sensor when the ultrasonic signal is received, is ascertained for the second ultrasonic sensor.

In step 550 of the method according to the present invention, the above result regarding the transmissivity of the second ultrasonic sensor is checked for plausibility by means of a conventional method, in which impedances of the transducers of the corresponding ultrasonic sensors are ascertained and assessed.

In step 600 of the method according to the present invention, it is checked whether the plausibility check of the blindness of the second ultrasonic sensor on the basis of the impedance assessment was successful. In this step, it is also checked whether a counter, which counts a multiple execution of the blindness ascertainment according to the present invention, has reached a predefined final value, which here corresponds to a value of three. Through the multiple passes of the method and through reconciling the individual results (by means of a majority decision) to obtain an overall result, filtering of potentially occurring short-term disturbances (e.g., as a result of changing road surfaces and/or puddles, etc. on the roadway) is achieved so that an overall result of the method according to the present invention has a higher reliability.

In the event that the current counter value has not yet reached the predefined final value, the method is continued in step 100.

In the event that the plausibility check was successful in step 550 and the final value of the counter was reached, the overall result for ascertaining the blindness of the ultrasonic sensors in the vehicle is output in step 700 of the method according to the present invention.

For example, the overall result is used here to ascertain a current range of the particular ultrasonic sensors on the basis of the current transmissivity of the corresponding ultrasonic sensors. Since the second ultrasonic sensor has a reduced transmissivity of 50%, a correspondingly lower range is ascertained for the second ultrasonic sensor than for the first ultrasonic sensor.

Due to the quantifiability of the blindness and/or transmissivity and/or range of the corresponding ultrasonic sensors, higher availability of the ultrasonic system in the vehicle is ensured since a vehicle function adapted to the reduced range of the second ultrasonic sensor can continue to be maintained.

Particularly advantageously, the method according to the present invention is carried out in successive passes in such a way that the function of the transmitting ultrasonic sensor is varied in accordance with a predefined transmission pattern.

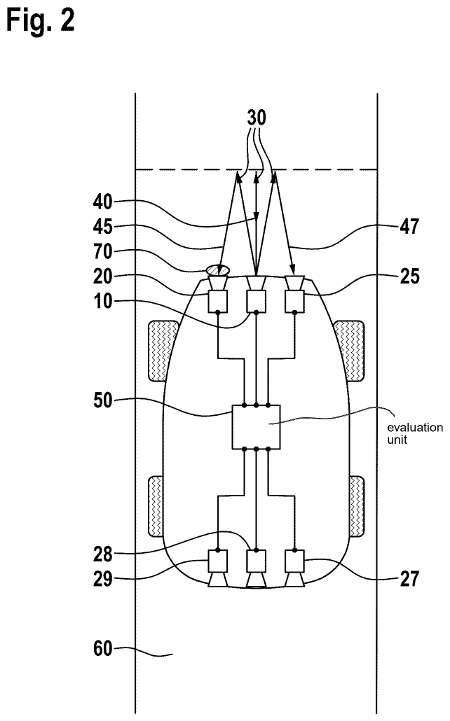

FIG. 2 shows a schematic view of an ultrasonic system according to the present invention in connection with a vehicle.

The ultrasonic system comprises a first ultrasonic sensor 10, a second ultrasonic sensor 20, and a third ultrasonic sensor 25, which are each arranged in a front region of the vehicle, with overlapping fields of view in each case.

Furthermore, the ultrasonic system comprises a fourth ultrasonic sensor 27, a fifth ultrasonic sensor 28, and a sixth ultrasonic sensor 29, which are each arranged in the rear region of the vehicle, with overlapping fields of view in each case.

All ultrasonic sensors 10, 20, 25, 27, 28, 29 are connected by information technology to an evaluation unit 50, which is designed as an ASIC and is a central component of the ultrasonic system.

It should be noted that the number of ultrasonic sensors may be different and that six front ultrasonic sensors and/or six rear ultrasonic sensors may be used particularly advantageously, for example.

While the vehicle travels along a roadway 60, the evaluation unit 50 carries out the above-described method according to the present invention, wherein the first ultrasonic sensor 10 transmits an ultrasonic signal 30, which is scattered in different directions when it impinges on the roadway 60. The dashed line in FIG. 1 represents a distance to the ultrasonic sensors 10, 20, 25 from which a particularly high proportion of ground echoes 40, 45, 47 is to be expected. It is understood that ground echoes 40, 45, 47 may also be received from shorter distances and/or longer distances. The particular scattered proportions of the ultrasonic signal 30 in the form of first ground echoes 40, second ground echoes 45, and third ground echoes 47 are reflected to the corresponding ultrasonic sensors 10, 20, 25.

Due to soiling 70 present in the field of view of the second ultrasonic sensor 20 at the second ultrasonic sensor 20, the second ground echo 45 is received with a correspondingly higher attenuation in the second ultrasonic sensor 20 than the ground echoes 45, 47 in the other ultrasonic sensors 10, 25. On the basis of these different attenuations, a degree of blindness of the second ultrasonic sensor 20 is ascertained by means of the evaluation unit 50.

In a case in which all front ultrasonic sensors 10, 20, 25 have substantially uniform soiling 70, on the basis of which it is not possible to ascertain different attenuations, it may be particularly advantageous if the method according to the present invention is performed in parallel for the rear ultrasonic sensors 27, 28, 29 independently of the front ultrasonic sensors 10, 20, 25 so that uniform soiling 70 of the front ultrasonic sensors 10, 20, 25 can be ascertained and taken into account on the basis of a comparison of the corresponding measurement signals between front ultrasonic sensors 10, 20, 25 and rear ultrasonic sensors 27, 28, 29.

1-10. (canceled)

11. A method for ascertaining a blindness of an ultrasonic sensor of an ultrasonic system, comprising the following steps:
transmitting an ultrasonic signal using a first ultrasonic sensor of the ultrasonic system into an environment of the first ultrasonic sensor;
generating a first measurement signal, which represents first ground echoes of the transmitted ultrasonic signal that are received by the first ultrasonic sensor;
generating a second measurement signal, which represents second ground echoes of the transmitted ultrasonic signal that are received by a second ultrasonic sensor of the ultrasonic system;
normalizing the first measurement signal and the second measurement signal; and
ascertaining a blindness of the first ultrasonic sensor and/or of the second ultrasonic sensor by comparing the first measurement signal with the second measurement signal.

12. The method according to claim 11, wherein the normalizing compensates for deviations with respect to respective:
orientations, and/or
arrangement positions, and/or
geometric attenuations, and/or
sound travel paths, and/or
technical properties,
of the first ultrasonic sensor and of the second ultrasonic sensor.

13. The method according to claim 11, wherein, when ascertaining the blindness of the first ultrasonic sensor and/or of the second ultrasonic sensor, a degree of the blindness and/or transmissivity of the corresponding ultrasonic sensor is quantified by normalizing signal values represented by the first and second measurement signals to signal values of the first and second ultrasonic sensors that
transmitted the ultrasonic signal and/or
has a highest signal value, in terms of magnitude, within the measurement signal.

14. The method according to claim 13, wherein, depending on the degree of the blindness and/or the transmissivity:
a range of a corresponding ultrasonic sensor is ascertained, and/or
a graduated error handling and/or system degradation is carried out.

15. The method according to claim 11, wherein the method is carried out with additional inclusion of at least a third measurement signal of at least a third ultrasonic sensor.

16. The method according to claim 11, wherein the method is carried out and/or a result of the method is classified as reliable only when:
interference signals contained in the ground echoes are below a predefined threshold value, wherein the interference signals are caused by noise and/or by direct echoes that are located within a distance range of the ground echoes, and/or
expected values for direct echoes received in addition to the ground echoes are met, and/or
the result was successfully checked for plausibility using at least one further measurement signal of at least one further ultrasonic sensor.

17. The method according to claim 11, wherein a result of the method is checked for plausibility and/or reconciled using a result of a different blindness detection method, in which
an impedance, and/or
a ratio of ground echoes to direct echoes,
of the first and second ultrasonic sensors is ascertained.

18. The method according to claim 11, wherein the blindness of the ultrasonic sensors is ascertained based on multiple measurements by the first and second ultrasonic sensors, corresponding results of which are reconciled with one another.

19. The method according to claim 11, wherein:
the method is executed multiple times, and
an assignment as to which of the first and second ultrasonic sensors of the ultrasonic system assumes a function of a transmitting ultrasonic sensor is adjusted according to a predefined transmission pattern during the multiple executions of the method.

20. An ultrasonic system, comprising:
a first ultrasonic sensor;
a second ultrasonic sensor; and
an evaluation unit;
wherein
the first ultrasonic sensor is configured to
transmit an ultrasonic signal into an environment of the first ultrasonic sensor,
generate a first measurement signal, which represents first ground echoes of the transmitted ultrasonic signal that are received by the first sensor,
the second ultrasonic sensor is configured to generate a second measurement signal, which represents second ground echoes of the transmitted ultrasonic signal that are received by the second sensor of the ultrasonic system, and
the evaluation unit is configured to
normalize the first measurement signal and the second measurement signal, and
ascertain a blindness of the first ultrasonic sensor and/or of the second ultrasonic sensor by comparing the first measurement signal with the second measurement signal.
